(19) United States
(12) Patent Application Publication
(10) Pub. No.: US 2009/0165053 A1
(43) Pub. Date: Jun. 25, 2009

(54) METHOD AND APPARATUS FOR PROVIDING ACCESS TO AND CONTROL OF MULTIMEDIA CONTENT INFORMATION ACROSS MULTIMEDIA PROCESSING DEVICES

(75) Inventors: Sundar Thyagarajan, Davie, FL (US); Daniel Baudino, Lake Worth, FL (US); Manish Mahajan, La Jolla, CA (US)

Correspondence Address: Motorola, Inc.;Law Department, 1303 East Algonquin Road, 3rd Floor, Schaumburg, IL, 60196, US

(73) Assignee: GENERAL INSTRUMENT CORPORATION, Horsham, PA (US)

(21) Appl. No.: 11/959,744

(22) Filed: Dec. 19, 2007

(51) Int. Cl. G06F 3/00

(52) U.S. Cl. 725/46

(57) ABSTRACT

A method and system for accessing and controlling multimedia content information, including end user profile information and EPG application information associated with the content, provided to and/or stored on a home multimedia processing device via a host or visiting multimedia processing device. Access by the host or visiting multimedia processing device can be controlled using a suitable control device, such as an end user mobile communication device associated with the host multimedia processing device. The control device is configured to make use of an end user profile application and an electronic program guide (EPG) application that allow authorized end users to enable the host multimedia processing device to be essentially an access client for the home multimedia processing device. Thus, an end user can access content associated with their home multimedia processing device using a host multimedia processing device located at a neighbor's house or other host location.

### BACKGROUND OF THE INVENTION

1. Field of the Invention

The invention relates to accessing and controlling multimedia content associated with a multimedia processing device, such as a set-top box or digital video recorder (DVR). More particularly, the invention relates to accessing end user profile information and electronic program guide (EPG) information associated with a home multimedia processing device via a different (host or visiting) multimedia processing device.

2. Description of the Related Art

Conventional content distribution system architecture for the flow of multimedia content, e.g., from Internet Protocol Television (IPTV) sources, is based on streaming content solutions. Likewise, distributing and controlling the flow of multimedia content from a multimedia processing device, such as a set-top box or DVR, to a viewing station or display device also is based on content streaming solutions. For example, some television streaming devices can redirect content streams from an end user's home set-top box or DVR to the end user's personal computer or other device using an Internet connection. Also, various software allows an end user to remotely access digital content, including multimedia content streamed to a multimedia processing device for display on a television set or other suitable display device.

However, many end users prefer to watch multimedia content on a television set (rather than on a computer screen) and to control the flow of the content via the television set's remote control unit. Portable end user communication devices, such as laptop computers, mobile phones and personal digital assistants (PDAs), were not necessarily designed for end users to enjoy an extended viewing experience. Also, with regard to providing multimedia content, steaming-based solutions often come with digital rights management (DRM) issues. For example, end user arrangements for some television streaming devices allow only one outbound content stream connection at a given time. For a typical family of end users, such arrangement can be unsatisfactory.

Nonetheless, the ability to access multimedia content streamed to one set-top box or DVR from another viewing station, such as a remote set-top box or DVR, is becoming more important to end users, particularly as set-top boxes, DVRs and other multimedia processing devices are increasingly viewed as another access client. Thus, service providers are being and/or will be forced to provide support for such displaced access to streaming multimedia content.

Conventional set-top boxes, DVRs and other multimedia processing devices support the concept of end user profiles and preferences, through which one or more end users associated with a single set-top box or DVR, e.g., a plurality of end users within a single household, can customize their respective favorite channels, viewing selections and other customizable information.

One relatively popular concept has been to provide profile support through individual end user mobile devices because of the relative ease of personalization. For example, conventional media players exist that allow a DVR to be controlled through a networked personal computer (PC) application or through an electronic program guide (EPG) application on a cellular telephone. Also, a mobile phone-based EPG utility exists that allows different end users to have different profiles and recording schedules on a multimedia content recording device, such as a DVR. Also, the capability of PC-based EPG applications that currently exist for PC media players may soon be transferred to end user mobile phones.

Currently, mobile EPG applications can be used only to view channel/program listings and schedule recordings on the associated recording device (DVR). Moreover, end users can associate their mobile EPG application only with a single set-top box/DVR, e.g., their primary or home set-top box/DVR. Accordingly, there is a need for end users to be able to access their respective profiles, as well as access and control multimedia content delivered to a home set-top box/DVR, from a different (host or visiting) set-top box, DVR or other multimedia processing device, e.g., using an EPG application interface, such as the end user's mobile telephone.

### BRIEF DESCRIPTION OF THE DRAWINGS

FIG. 1 is a block diagram of a system for providing access to and control of multimedia content information associated with one multimedia processing device via another multimedia processing device;

FIG. 2 is a block diagram of a host or visiting multimedia processing device configured for use in the system of FIG. 1;

FIG. 3 is a block diagram of a mobile communication device configured for use in the system of FIG. 1;

FIG. 4 is a block diagram of a method for providing access to and control of multimedia content information associated with one multimedia processing device via another multimedia processing device.

### DETAILED DESCRIPTION

In the following description, like reference numerals indicate like components to enhance the understanding of the multimedia content access and control methods, devices and systems through the description of the drawings. Also, although specific features, configurations and arrangements are discussed herein below, it should be understood that such specificity is for illustrative purposes only. A person skilled in the relevant art will recognize that other steps, configurations and arrangements are useful without departing from the spirit and scope of the invention.

The methods, devices and systems described herein involve accessing and controlling multimedia content information, including EPG application information associated with the multimedia content, provided to and/or stored on home multimedia processing device via a different (host or visiting) multimedia processing device. Access by the host multimedia processing device can be controlled using a suitable control device, such as an end user mobile communication device, such as a mobile telephone, associated with the host multimedia processing and/or the device's remote control unit. The control device or devices are configured appropriately to make use of an end user profile application, an electronic program guide (EPG) application, and other suitable applications that allow authorized end users to enable the host multimedia processing device to be essentially an access client for the home multimedia processing device. The host multimedia processing device typically is within the same multimedia content service provider network as the home multimedia processing device, although the host multimedia processing device can be in the same or a different geographical location as the home multimedia processing device. For example, in this manner, an end user can access multimedia content provided to and/or stored on the end user's home multimedia processing device from a host multimedia processing device located at a neighbor's house, a hotel, or other visiting location.

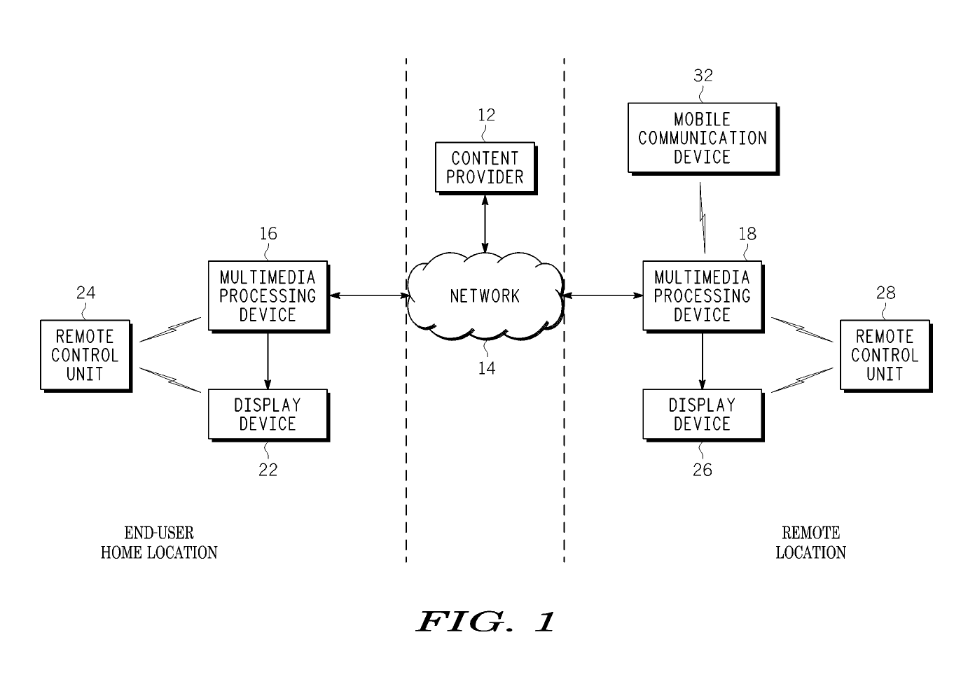

Referring to FIG. 1, shown is a block diagram of a system 10 for providing access to and control of multimedia content information associated with a local or home multimedia processing device via an host multimedia processing device. For example, the associated multimedia content can be multimedia content provided to and/or stored on the home multimedia processing device. The system includes a multimedia content source or provider 12, a network 14, a local or home (first) multimedia processing device 16 coupled to the network 14 and at least one host or visiting (second) multimedia processing device 18 also coupled to the network 14. The home multimedia processing device 16 typically is located at a location local to the end user, such as within the end user's home. The host multimedia processing device 18 is at a different location from the home multimedia processing device 16, such as at a host or visiting location, e.g., at a hotel or the home of a friend of the end user. It should be understood that the host multimedia processing device 18 does not have to be located outside of the end user home location, e.g., the host multimedia processing device 18 can be located within the end user's home, but in a different room from that of the home multimedia processing device 16.

The multimedia content source 12 can be any suitable transmission source of multimedia content, such as over-the-air broadcasters, from a cable television plant, satellite service provider or other multimedia service provider. The multimedia content can be any suitable multimedia content, including movies, programming events, music, photos and/or other multimedia content that is distributed, e.g., as one or more programming streams from a broadcast source or other suitable multimedia content source. The multimedia content can include one or more system applications, such as a television application, a video on demand (VOD) application, an electronic program guide (EPG) application, end user profile applications, and other suitable applications, such as teletext applications, web/portal browser applications and settings applications. The multimedia content system applications include the actual program commands and instructions that interact with multimedia processing devices and their end users. The multimedia content typically is a plurality of digital signals formatted according to a suitable standard, such as the MPEG (Moving Picture Experts Group) 2 or MPEG 4 standard, and multiplexed into a data stream that is modulated on a carrier using quadrature amplitude modulation (QAM) or other suitable modulation technique.

The network 14 can be any communication network or network server arrangement suitable for transmitting multimedia content from the multimedia content source 12 to one or more multimedia processing devices. For example, the network 14 can be or include the Internet or an Internet protocol (IP) based network, or other suitable public network. The network 14 also can be or include a computer network, a web-based network or other suitable wired or wireless network or network system, including in-home personal networks. Also, at least a portion of the network 14 can be any wired or wireless wide area network (WAN), local area network (LAN) or wireless local area network (WLAN), such as a residential network. The multimedia processing devices, as well as the multimedia content source 12, can be coupled to the network 14 via one or more suitable wired connections and/or wireless communications. Such suitable connections include one or more coaxial cables and/or optical fibers, including a Hybrid Fiber Coaxial (HFC) cable system, Fiber To The Premises (FTTP) systems, such as Fiber To The Curb (FTTC) or Fiber To The Home (FTTH), or over any suitable number of digital subscriber line systems (xDSL).

The home or local multimedia processing device 16 can be partially or completely any suitable device or subsystem (or portion thereof) for receiving multimedia content from a content source 12, processing or decoding the received multimedia content, and transmitting or transferring the processed multimedia content to an end user display device 22, such as a television, a computer monitor or other suitable display device. The home or local multimedia processing device 16 typically includes a handheld remote control device 24, which transmits access and control commands from the end user to the multimedia processing device 16. The multimedia processing device 16 decodes the commands and forwards control signals to the appropriate circuits in the multimedia processing device 16 to carry out the commands. The handheld remote control device 24 also can transmit commands to the display device 22, such as adjustment commands for volume control and display settings.

The multimedia processing device 16 can be any digital video recorder (DVR) or digital video server (DVS) device, including any signal converter or decoder (set-top) box with internal and/or external recording capabilities and local and/or remote storage, which often are referred to as personal video recorder (PVR) devices. Other suitable multimedia processing devices include a residential gateway, a home media server system, a digital video disk recorder, a computer, a television with built-in or added-on multimedia content receiving and/or storing capability, or other suitable computing devices or video devices, including internet protocol (IP), satellite and cable digital video recorders, and home area network (HAN) devices and systems. Although the display device 22 typically is a separate component from the multimedia processing device 16, it should be understood that the multimedia processing device 16 and a display device can be combined or integrated as a single component.

The host multimedia processing device 18 is similar to the home multimedia processing device 16. The host multimedia processing device 18 is configured to receive and process multimedia content, and transmit or transfer the processed multimedia content to an appropriate end user display device 26. The host multimedia processing device 18 also can include a handheld remote control device 28 for transmitting access and control commands from the end user to the host multimedia processing device 18. Also, as will be discussed in greater detail hereinbelow, the host multimedia processing device 18 can be configured to receive access and control commands from an end user communication device, such as a mobile communication device 32, that has been properly associated with the host multimedia processing device 18.

The mobile communication device 32 can be any suitable mobile communication device configured to receive and transmit multimedia content, such as a mobile or cellular telephone, a smartphone, a personal digital assistant (PDA) or other wireless handheld device with such capability. The mobile communication device 32 is discussed in greater detail hereinbelow. Alternatively, the end user communication device can be a digital camera, a laptop personal computer (PC) and/or a notebook PC configured with the ability to receive and transmit multimedia content.

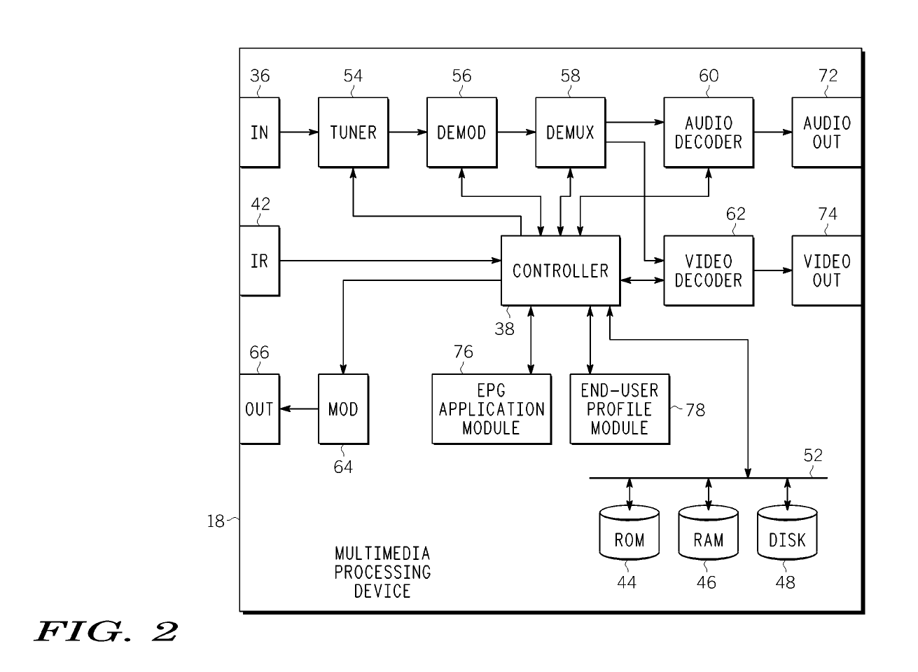

Referring now to FIG. 2, with continuing reference to FIG. 1, shown is a block diagram of a host multimedia processing device, such as the host multimedia processing device 18, configured for providing access to and control of multimedia content associated with an end user's home or local multimedia processing device, such as the home multimedia processing device 16. The host multimedia processing device 18 includes an input port or interface 36 for receiving multimedia content, e.g., from the multimedia content source 12. As discussed hereinabove, the multimedia content typically is a QAM-modulated MPEG2 or MPEG4 digital stream. However, the multimedia content can be analog or digital content. If the multimedia content is analog, an MPEG encoder or other suitable encoder (not shown) can be included as part of the multimedia processing device 18.

The multimedia processing device 18 includes a controller or processing unit 38. In general, the controller 38 processes information received by the multimedia processing device 18. The controller 38 can include at least one type of memory or memory unit (not shown) and a storage unit or data storage unit coupled to the processor for storing processing instructions and/or information received by the multimedia processing device 18. The controller 38 can be central processing unit (CPU) that includes any digital processing device, such as a microprocessor, finite state machine (FSM), digital signal processor (DSP), application specific integrated circuit (ASIC) and/or general purpose computer. The controller 38 typically receives commands from the end user, such as through infrared (IR) reception of commands from a handheld remote control device (e.g., the remote control unit 28) through an IR receiving circuit 42. The controller 38 decodes the commands and forwards control signals to other circuits in the multimedia processing device 18 to carry out the commands, such as changing the channel.

The multimedia processing device 18 can include a read only memory (ROM) 44 containing software and fixed data used for operating the multimedia processing device 18, and a random access memory (RAM) 46 for storing changeable data. The multimedia processing device 18 also can include a separate internal or external large memory device, such as a hard disk drive or other storage element 48 for storing relatively large amounts of multimedia content. Alternatively, the hard disk can be any suitable information storage unit, such as any suitable magnetic storage or optical storage device, including magnetic disk drives, magnetic disks, optical drives, optical disks, and memory devices, including flash memory. The controller 38, the ROM 44, the RAM 46 and the hard disk 48 are coupled to a master bus 52 over which the units can communicate with each other.

Within the multimedia processing device 18, received multimedia content from the input port 36 passes through a tuner or tuning circuit 54. Under control of the controller 38, the tuning circuit 54 selectively parses out the data corresponding to the particular channel selected by the viewer or end user. The selected data is passed to a demodulator 56, which demodulates the data. It should be understood that the tuning circuit 54 and the demodulator 56 can be a single component or processing circuit.

The demodulated multimedia content data passes to a demultiplexor (demux) 58, such as an MPEG2 transport stream parser (TPP). The demodulated multimedia content data passes to the demux 58 directly from the demodulator 56 and/or through the controller 38. The demux 58 receives the demodulated multimedia content and separates or demultiplexes the audio and video portions of the multimedia content.

An audio decoder 60 processes the MPEG audio stream and produces an analog audio signal. A video decoder 62 decompresses the MPEG video and generates a video sequence. After decoding, the demultiplexed information can be stored in memory buffers to form a data stream. In such case, the audio decoder 60 and the video decoder 62 can pass the decoded multimedia content to one or more of the memory devices 46, 48 through the controller 38. The audio and video portions of the multimedia content also are forwarded to an audio output port or interface 72 and a video output port or interface 74, respectively. The audio output interface 72 and the video output interface 74 transfer the processed multimedia content, including stored multimedia content, to an end user display device, such as the display device 26.

Depending on the particular features of the multimedia processing device 18, the multimedia processing device 18 may include a modulator 64 coupled to the controller 38 for modulating data generated by various system resources in the multimedia processing device 18 and/or the controller 38 for transmission upstream. The modulator 64 is coupled to an output port or interface 66, which can be coupled to the network 14 or other appropriate connection. It should be understood that the interface 36 and the interface 66 can be the same physical port, i.e., the interface 36 and the interface 66 can be a single input/output interface.

The multimedia processing device 18 also includes an EPG application or EPG application module 76 coupled to, contained within and/or executed by the controller 38. The EPG application 76 can be implemented in software, e.g., using operating system elements instantiated in the software architecture of the multimedia processing device 18, although such is not necessary. As will be discussed in greater detail hereinbelow, the EPG application module 76 processes EPG information, such as available multimedia content programs and channel lineups. The EPG application module 76 also is configured to exchange EPG information and EPG application information with the multimedia content provider 12 and the home multimedia processing device 16, e.g., via the network 14. The EPG application module 76 also communicates EPG application information to and from appropriate control devices associated with the multimedia processing device 18, e.g., the mobile communication device 32.

The multimedia processing device 18 also includes an end user profile application or module 78 coupled to, contained within and/or executed by the controller 38. The end user profile application 78 can be implemented in software, e.g., using operating system elements instantiated in the software architecture of the multimedia processing device 18, although such is not necessary. As will be discussed in greater detail hereinbelow, the end user profile module 78 receives and processes end user profile information, which includes subscriber-specific information for the one or more end users of the home multimedia processing device 16. The end user profile module 78 receives end user profile information from any suitable device associated with the multimedia processing device 18, e.g., the mobile communication device 32. The end user profile module 78 also is configured to communicate with the multimedia content provider 12 and the home multimedia processing device 16, e.g., as needed, as will be discussed in greater detail hereinbelow.

One or more of the controller 38, the IR receiving circuit 42, the ROM 44, the RAM 46, the hard disk 48, the master bus 52, the tuner 54, the demodulator 56, the demux 58, the audio decoder 60, the video decoder 62, the modulator 64, the interfaces 36, 42, 66, 72, 74, the EPG application 76 and the end user profile application 78 can be comprised partially or completely of any suitable structure or arrangement, e.g., one or more integrated circuits. Also, it should be understood that the multimedia processing device 18 includes other components, hardware and software (not shown) that are used for the operation of other features and functions of the multimedia processing device 18 not specifically described herein.

The multimedia processing device 18 can be partially or completely configured in the form of hardware circuitry and/or other hardware components within a larger device or group of components. Alternatively, the multimedia processing device 18 can be partially or completely configured in the form of software, e.g., as processing instructions and/or one or more sets of logic or computer code. In such configuration, the logic or processing instructions typically are stored in a data storage device, e.g., the ROM 44, the RAM 46 and/or the hard disk 48 or other suitable data storage device (not shown). The data storage device typically is coupled to a processor or controller, e.g., the controller 38, or other suitable processor or controller (not shown). The processor accesses the necessary instructions from the data storage device and executes the instructions or transfers the instructions to the appropriate location within the multimedia processing device 18.

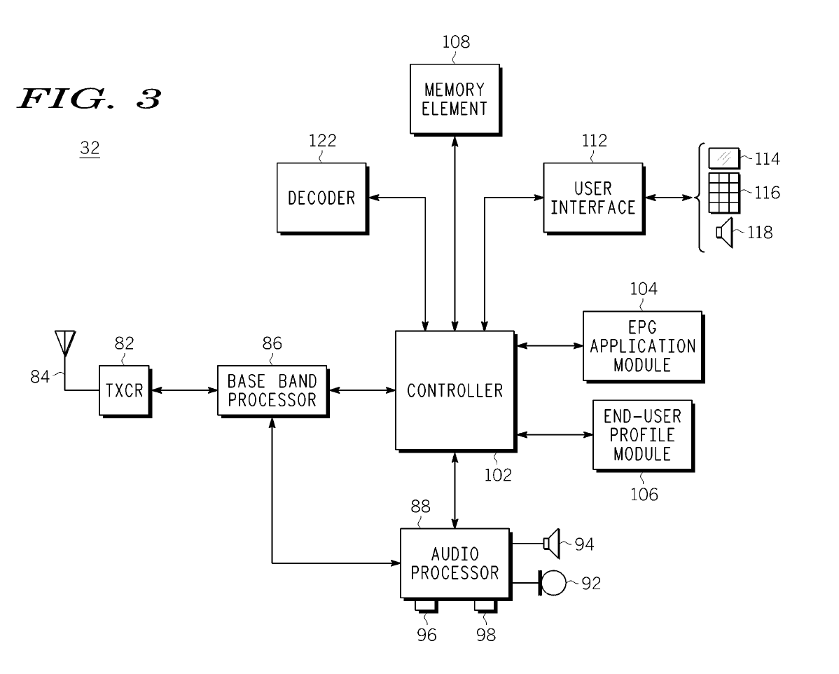

Referring now to FIG. 3, with continuing reference to FIG. 1, shown is a block diagram of an end user communication device, such as the mobile communication device 32, configured for use in providing access to and control of multimedia content associated with a home multimedia processing device, such as the home multimedia processing device 16, to a host or visiting multimedia processing device, such as the host multimedia processing device 18. As discussed hereinabove, the mobile communication device 32 can be a mobile or cellular telephone, a smartphone, a personal digital assistant (PDA) or other suitable end user communication device.

The mobile communication device 32 typically includes a mobile communications transceiver 82, which modulates and demodulates, filters, and amplifies signals sent and received over an antenna 84, according to suitable air interface communication protocols. The transceiver 82 is coupled to a baseband processor 86, which digitally processes information to be transmitted by, or that has been received from, the transceiver 82. For example, the baseband processor 86 encodes voice signals and applies forward error correction, digital filtering and other digital processing.

The mobile communication device 32 also typically includes an audio processor 88 coupled to the baseband processor 86. The audio processor 88 converts analog signals of an acoustic origin to digital signals, and vice versa. For example, when a user of the mobile communication device 32 speaks, a microphone 92 coupled to the audio processor 88 converts the acoustic signal to an analog electrical signal, which is processed and digitized by the audio processor 88 to produce a digital signal, which is fed to the baseband processor 86. Similarly, the baseband processor 86 receives demodulated signals from the transceiver 82, and processes the demodulated signals to provide digital audio signals to the audio processor 88. The audio processor 88, in turn, converts the digital audio signals to analog signals, which are played over a speaker 94 that is coupled to the audio processor 88.

The audio processor 88 can have one or more coupling ports or interfaces 96, 98 for connecting additional audio devices, such as accessory devices, to the mobile communication device 32. It should be understood that the interfaces 96, 98 can be a single interface configured to connect to multiple audio devices, including accessory devices. Also, it should be understood that additional audio devices can be connected to the audio processor 88 via an extended mode universal (EMU) serial bus (not shown) or other suitable connection components.

The baseband processor 86 and the audio processor 88 are coupled to a controller or application processor 102, which is the central processor of the mobile communication device 32, and is coupled to all major subsystems of the mobile communication device 32. The controller 102 is coupled to and/or includes an EPG application or module 104 for transmitting, processing and receiving EPG information. Also, the controller 102 is coupled to and/or includes an end user profile application or module 106 for transmitting, processing and receiving end user profile information. One or both of the EPG application 104 and the end user profile application 106 can be implemented in software, e.g., using operating system elements instantiated in the software architecture of the mobile communication device 32.

The mobile communication device 32 also typically includes a memory element or storage device 108 coupled to the controller 102. The memory element 108 can store application programs and data structures used by application programs, as well as other information. The memory element 108 can be any suitable information storage unit, such as any suitable magnetic storage or optical storage device, including magnetic disk drives, magnetic disks, optical drives, optical disks, and memory devices, including random access memory (RAM) devices, and flash memory. Although represented here abstracted as a single block, the memory element 108 can include multiple memory elements, including a variety of memory types, such as those provided hereinabove. Also, although the memory element 108 is shown as an internal part of the mobile communication device 32, the memory element 108 can be located external to the mobile communication device 32 and suitably coupled thereto.

The controller 102 also operates a user interface 112 coupled thereto, which also is abstracted here as a single block. It should be understood that the user interface 112 involves a variety of hardware and software elements for allowing a user of the mobile communication device 32 to interact with the mobile communication device 32, including inputting information and commands, and receiving information. The user interface 112 includes various interface elements, such as a graphical display 114, a keypad and buttons 116, and an audio transducer 118 for producing audible alerts, such as ringing when a call is attempting to be made to the mobile communication device 32.

The mobile communication device 32 also can include a decoder 122 coupled to and/or contained within the controller 102. The decoder 122 is configured to decode and/or identify various information from among the information received by the mobile communication device 32 and to provide such information to the controller 102 for further processing.

One or more of the transceiver 82, the baseband processor 86, the audio processor 88, the controller 102, the EPG application 104, the end user profile application 106, the memory element 108, the user interface 112, the decoder 122 and other components in the mobile communication device 32 can be comprised partially or completely of any suitable structure or arrangement, e.g., one or more integrated circuits. Also, it should be understood that the mobile communication device 32 includes other components, hardware and software (not shown) that are used for the operation of other features and functions of the mobile communication device 32 not specifically described herein.

The mobile communication device 32 can be partially or completely configured in the form of hardware circuitry and/or other hardware components within a larger device or group of components. Alternatively, the mobile communication device 32 can be partially or completely configured in the form of software, e.g., as processing instructions and/or one or more sets of logic or computer code. In such configuration, the logic or processing instructions typically are stored in a data storage device, e.g., the memory element 108 or other suitable data storage device (not shown). The data storage device typically is coupled to a processor or controller, e.g., the controller 102 or other suitable processor or controller (not shown). The processor accesses the necessary instructions from the data storage device and executes the instructions or transfers the instructions to the appropriate location within the mobile communication device 32.

It should be understood that the end user communication device does not have to be a mobile telephone or other mobile communication device. For example, the remote control unit 28 associated with the multimedia processing device 18 can be configured for use in the same manner as the mobile communication device 32 or other appropriate control device in providing access to and control of multimedia content associated with the local multimedia processing device 16 to the host multimedia processing device 18.

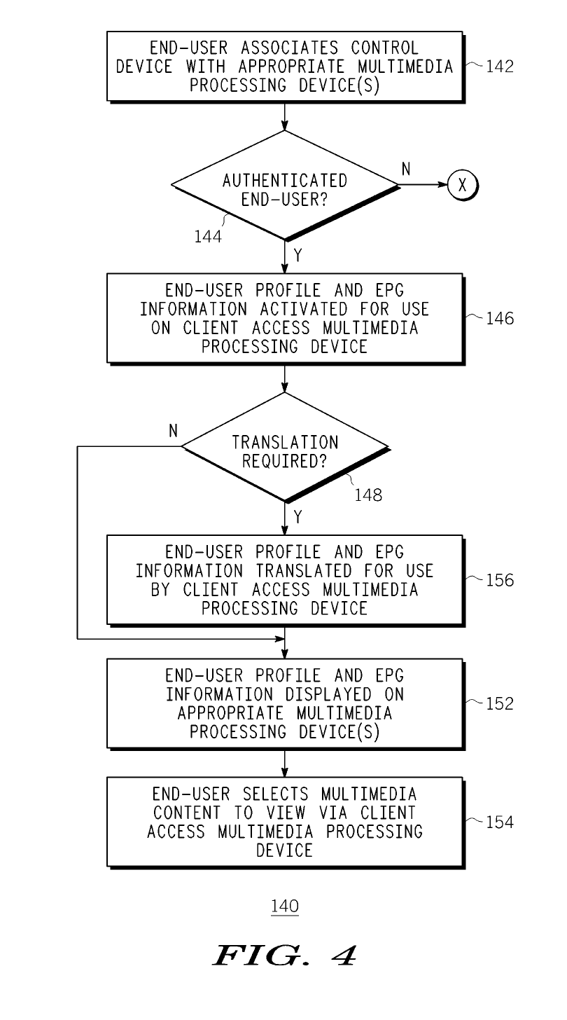

Referring now to FIG. 4, with continuing reference to FIGS. 1-3, shown is a block diagram of a method 140 for providing access to and control of multimedia content information associated with a home multimedia processing device via a host or visiting multimedia processing device. The method 140 will be described generally and in the context of several use cases or scenarios that illustrate the access and control of multimedia content information associated with a home multimedia processing device by a host multimedia processing device. The first use case involves a host multimedia processing device that is located within the same geographical location and serviced by the same service provider as the home multimedia processing device. For example, an end user has a first (home) multimedia processing device 16 in his home and desires to access multimedia content provided to and/or stored on his home multimedia processing device 16 from a second (host) multimedia processing device located at the home of a friend of the end user. In this scenario, the friend's home is located in the same city as the home of the end user and uses the same service provider, e.g., cable television company, as the end user.

The method 140 includes a step 142 of associating an end user control device with the appropriate multimedia processing device or devices in such a way that the end user control device can communicate with the multimedia processing device that has been associated therewith. For example, the end user can associate the mobile communication device 32 or other suitable control device with the appropriate multimedia processing device. In this use case, the end user associates the control device with the host multimedia processing device 18 so that the end user can transmit appropriate instructions to the host multimedia processing device 18, via the end user control device, for accessing multimedia content associated with the home multimedia processing device 16. Alternatively, the end user also can associate the mobile communication device 32 with the end user's home multimedia processing device 16, as will be discussed in greater detail hereinbelow. The end user can use any suitable process to associate the control device with the multimedia processing device(s), e.g., using a suitable radio-frequency identification (RFID) or near field communication (NFC) association authentication scheme, or any suitable IP-based authentication process.

The method 140 also includes a step 144 of authenticating the end user. Once the end user control device has been associated with the host multimedia processing device 18 (step 142), the end user can direct the end user control device (e.g., the mobile communication device 32) to send various commands and other information to the host multimedia processing device 18. Accordingly, the end user, via the end user control device, can instruct the host multimedia processing device 18 (and/or the home multimedia processing device 16) to send a request for authentication to the content provider 12, e.g., to the provider's content IP server (not shown). The request for authentication includes appropriate subscription information that identifies the end user as a system subscriber associated with the home multimedia processing device 16. Such information may also include any necessary passwords, user access codes or other information identifying the credentials of the end user and the end user's association with the home multimedia processing device 16, as well as the various services and multimedia content that the end user is authorized to receive and access. The subscription information sent can be retrieved from an appropriate location, such as the end user's home multimedia processing device 16 (e.g., from an end user profile module) and/or the end user's control device, e.g., the end user's mobile communication device 32 (e.g., from the end user profile module 106).

The method 140 also includes a step 146 of activating, providing or otherwise making available end user profile information (and corresponding EPG information) of the requesting end user for use on the host multimedia processing device 18. In response to the request for authentication, if the service provider 12 fails to authenticate the end user, the end user will not be able to access and/or control content via the host multimedia processing device 18. However, if the service provider 12 authenticates the end user (which is assumed in this use case), the service provider 12 can send confirmation information to the appropriate multimedia processing device, e.g., the host multimedia processing device 18. Such confirmation information can include any information necessary to allow the end user's profile information (and corresponding EPG information available to such end user) to be accessed by the host multimedia processing device 18.

Depending on which multimedia processing device sent the authentication request, the service provider 12 can send the authentication confirmation information to the host multimedia processing device 18 and/or the home multimedia processing device 16. If the confirmation information is sent to the home multimedia processing device 16 only, the home multimedia processing device 16 is configured to forward such information to the host multimedia processing device 18, e.g., via the network 14. Within the multimedia processing device 18, such confirmation information is received and processed by the end user profile module 78.

The end user's end user profile information can include any information relating to the particular end user, including the settings, preferences, privileges, restrictions, billing arrangements, stored content and other appropriate information specific to the end user, the end user's subscription with the content provider 12, and the end user's home multimedia processing device 16. The EPG information to be made available to the end user via the host multimedia processing device 18 is the same EPG information presented to or accessed by the end user through the end user's home multimedia processing device 16 as part of the end user's subscription with the content provider 12.

The method 140 also includes a step 148 of determining whether or not the end user's profile information and/or corresponding EPG information should be translated. As will be discussed in greater detail hereinbelow as part of the discussion of another use case, the end user's profile information and EPG information may have to be translated before such information can be received by the appropriate multimedia processing device, e.g., the host multimedia processing device 18, and accessed by the end user via the host multimedia processing device 18. However, in the current use case being described, the home multimedia processing device 16 and the host multimedia processing device 18 are assumed to be in the same service provider geographical location (and time zone) and serviced by the same content provider 12, therefore no translation should be required. That is, the end user profile information and EPG information configured for receipt and processing by the home multimedia processing device 16 also is suitable for receipt and processing by the host multimedia processing device 18.

The method 140 also includes a step 152 of displaying end user profile information on an appropriate multimedia processing device, e.g., the host multimedia processing device 18. The host multimedia processing device 18 is configured in such a way that, once the end user has been authenticated, the host multimedia processing device 18 can receive and display end user profile information associated with the end user and the end user's home multimedia processing device 16, and corresponding EPG information, as if the host multimedia processing device 18 was the home multimedia processing device 16. The host multimedia processing device 18 can display the received information on any suitable display device, e.g., the display device 26 associated with the host multimedia processing device 18. In this manner, the host multimedia processing device 18 becomes an access client device of the home multimedia processing device 16.

The end user profile information and/or corresponding EPG information of the end user can be displayed by the multimedia processing device 18 in response to appropriate commands received from the mobile communication device 32, e.g., from the end user profile module 106 and/or the EPG application module 104. Alternatively, the multimedia processing device 18 can display the end user profile information and/or corresponding EPG information using appropriate instructions from the EPG application module 76 and/or the end user profile module 78. In such case, the multimedia processing device may receive appropriate display commands from the remote control unit 28.

The method 140 also includes a step 154 of selecting multimedia content to view via the host multimedia processing device 18. Once the end user's profile information and EPG information has been or can be received by the host multimedia processing device 18, the end user can select multimedia content to view from the EPG information displayed on the display device 26, which is the result of the step 152 of displaying the end user profile information and corresponding EPG information. The end user also can view the selected material based on the end user preferences and other criteria included in the end user profile information that has been or can be received by the host multimedia processing device 18.

In this manner, the host multimedia processing device 18 effectively has become an access client device for the end user's home multimedia processing device 16. Therefore, using the multimedia processing device 18 at the home of the end user's friend, the end user has access to and control of multimedia content normally associated with the end user's home multimedia processing device 16. That is, the end user can access multimedia content personalized for and/or customized by the end user, using the friend's multimedia processing device 18. Such personalized and/or customized multimedia content includes any multimedia content that typically is provided to and/or stored on the end user's home multimedia processing device 16. Once the end user has been authenticated, the end user's profile information and EPG application information can be used by the multimedia processing device 18 and the mobile communication device 32 to send the necessary commands and information to the service provider 12 and the home multimedia processing device 16, e.g., via the network 14, to access and control the flow of the end user's multimedia content. For example, the end user can retrieve a movie stored on the home multimedia processing device 16 and have it displayed on the display device 26 associated with the multimedia processing device 18.

In another scenario or use case illustrating the access and control of multimedia content information associated with a home multimedia processing device by a host multimedia processing device, the end user's home multimedia processing device 16 and the end user friend's host multimedia processing device 18 are assumed to be in different geographical locations, e.g., to the extent that the format or configuration of the EPG information used in the location of the home multimedia processing device 16 does not match or is not readily compatible with the format or configuration of the EPG information used in the location of the host multimedia processing device 18. For example, the respective channel lineups, time zones and/or other format or configuration parameters of the EPG information in the respective geographical locations is different.

In this particular use case, much of the method 140 is the same as with the first use case previously described herein. However, since the EPG information formats of the respective multimedia processing devices are different, a translation step must be performed before EPG information configured for use by the home multimedia processing device 16 can be used by the host multimedia processing device 18. As part of this translation, the location or location code of the host multimedia processing device 18 is provided to the service provider 12, e.g., as part of or in addition to the step 142 of associating the control device with the host multimedia processing device 18. Such location or location code also can be provided to the service provider 12 by the host multimedia processing device 18, e.g., as part of or in response to the associating step 142.

The method 140 also includes a step 156 of translating end user profile information and EPG information for use by the host multimedia processing device 18. Once the end user has been authenticated and the end user's profile information and EPG information can be accessed and received by the host multimedia processing device 18 (i.e., step 146), and it has been determined that such information should be translated (step 148), the translation step 156 is performed so that the end user profile information and EPG information are translated properly for use by the host multimedia processing device 18. The information can be translated using any one or more of a number of suitable translation processes.

As an example, assume that the content being shown on channel 31 in the location of the home multimedia processing device 16 is shown on channel 55 in the location of the host multimedia processing device 18. When the end user attempts to access channel 31 via the host multimedia processing device 18, the service provider 12 translates the request to the format or configuration of the host multimedia processing device 18, i.e., a request for content shown on channel 55. Instead of or in addition to the translation processes performed by the service provider 12, such translation capability can be part of the host multimedia processing device 18, e.g., as part of the front-end processing of the host multimedia processing device 18. Therefore, in this manner, even though the home multimedia processing device 16 and the host multimedia processing device 18 are located in different areas for purposes of interpreting EPG information, such as channel lineups, the host multimedia processing device 18 still can be used as an access client device for the home multimedia processing device 16. It should be understood that any EPG translation should include allowances for time zone differences and translate accordingly.

In a variation of the use cases described hereinabove, the methods and devices described herein can be used to allow end user profile information and EPG information, and thus access to corresponding multimedia content, to “follow” the end user or be moved from the end user's primary or home multimedia processing device to one or more other multimedia processing devices, e.g., in other rooms in the home of the end user. In this manner, in general, the end user profile, EPG information and multimedia content can seamlessly “follow” the end user from multimedia processing device to multimedia processing device.

The methods, devices and systems described herein allow an end user to access personalized information and content via one or more host multimedia processing devices, which may be in the same or different geographical location as the end user's home multimedia processing device. Accordingly, the end user enjoys a relatively seamless and convenient experience via visiting multimedia processing devices through the dynamic network translation of mobile EPG selections, e.g., as described hereinabove.

The method shown in FIG. 4 may be implemented in a general, multi-purpose or single purpose processor. Such a processor will execute instructions, either at the assembly, compiled or machine-level, to perform that process. Those instructions can be written by one of ordinary skill in the art following the description of FIG. 4 and stored or transmitted on a computer readable medium. The instructions may also be created using source code or any other known computer-aided design tool. A computer readable medium may be any medium capable of carrying those instructions and includes random access memory (RAM), dynamic RAM (DRAM), flash memory, read-only memory (ROM), compact disk ROM (CD-ROM), digital video disks (DVDs), magnetic disks or tapes, optical disks or other disks, silicon memory (e.g., removable, non-removable, volatile or non-volatile), packetized or non-packetized wireline or wireless transmission signals.

It will be apparent to those skilled in the art that many changes and substitutions can be made to the multimedia content access and control methods, devices and systems herein described without departing from the spirit and scope of the invention as defined by the appended claims and their full scope of equivalents.

1. A host multimedia processing device, wherein the host multimedia processing device is coupled to a home multimedia processing device and coupled to a multimedia content provider via at least one network, wherein the host multimedia processing device comprises:
a controller configured to receive multimedia content from the multimedia content provider;
a memory element coupled to the controller for storing at least a portion of the multimedia content received by the controller; and
an end user profile module coupled to the controller,
wherein the end user profile module is configured for processing end user profile information associated with an end user of the home multimedia processing device in such a way that the multimedia processing device accesses and controls multimedia content associated with the end user and the home multimedia processing device.

2. The device as recited in claim 1, wherein the multimedia processing device accesses and controls multimedia content associated with the end user and the home multimedia processing device in response to end user profile information received by the multimedia processing device from at least one end user communication device.

3. The device as recited in claim 2, wherein the at least one end user communication device is selected from the group consisting of a cellular telephone, a smartphone, a personal digital assistant (PDA) device, a wireless handheld device, a mobile communication device, a digital camera, a desktop personal computer (PC), a laptop PC, a notebook PC, a signal converter box, a signal decoder box, a digital video recorder, a digital video disk recorder, a personal video recorder device, a set-top box, a home media server, a digital video server, a residential gateway and a video receiver.

4. The device as recited in claim 1, further comprising an electronic program guide (EPG) application module coupled to the controller, wherein the EPG application module is configured for processing EPG information associated with the end user of the home multimedia processing device in such a way that the multimedia processing device accesses and controls multimedia content associated with the end user and the home multimedia processing device.

5. The device as recited in claim 4, wherein at least one of the multimedia content provider and the home multimedia processing device provides the EPG information to the multimedia processing device.

6. The device as recited in claim 4, wherein the multimedia processing device is configured to display at least a portion of at least one of the EPG information and the multimedia content on a display device coupled to the multimedia processing device.

7. The device as recited in claim 1, wherein at least one the multimedia content provider and the home multimedia processing device provides access to the end user profile information by the multimedia processing device.

8. The device as recited in claim 1, wherein the multimedia processing device is configured to display at least a portion of at least one of the end user profile information and the multimedia content on a display device coupled to the multimedia processing device.

9. The device as recited in claim 1, wherein the multimedia processing device is selected from the group consisting of a signal converter box, a signal decoder box, a digital video recorder, a digital video disk recorder, a personal video recorder device, a set-top box, a home media server, a digital video server, a residential gateway and a video receiver.

10. A method for accessing multimedia content associated with a home multimedia processing device using a host multimedia processing device, comprising the steps of:
receiving, in response to authentication of an end user of the home multimedia processing device, electronic program guide (EPG) information by the host multimedia processing device for use by the multimedia processing device, wherein the received EPG information is associated with the home multimedia processing device;
accessing by the host multimedia processing device multimedia content associated with the end user and the home multimedia processing device, based on the received EPG information; and
controlling the access of the multimedia content received by the host multimedia processing device based on the received EPG information.

11. The method as recited in claim 10, further comprising the step of receiving end user profile information by the host multimedia processing device that has been provided for use by the multimedia processing device, wherein the end user profile information is associated with the end user of the home multimedia processing device.

12. The method as recited in claim 11, wherein the accessing step includes accessing by the host multimedia processing device multimedia content associated with the end user and the home multimedia processing device, based on the received end user profile information.

13. The method as recited in claim 11, wherein the controlling step includes controlling the access of the multimedia content received by the host multimedia processing device based on the received end user profile information.

14. The method as recited in claim 10, further comprising the step of associating an end user control device with the host multimedia processing device, and wherein at least one of the receiving, accessing and controlling steps are performed in response to information received by the host multimedia processing device from the end user control device.

15. The method as recited in claim 14, wherein the end user control device is selected from the group consisting of a cellular telephone, a smartphone, a personal digital assistant (PDA) device, a wireless handheld device, a mobile communication device, a digital camera, a desktop personal computer (PC), a laptop PC, a notebook PC, a signal converter box, a signal decoder box, a digital video recorder, a digital video disk recorder, a personal video recorder device, a set-top box, a home media server, a digital video server, a residential gateway and a video receiver.

16. The method as recited in claim 10, further comprising a step of authenticating the end user by a provider of the multimedia content before activating the EPG information by the multimedia content provider for use by the host multimedia processing device.

17. The method as recited in claim 10, wherein the multimedia content is formatted according to a first format compatible with the home multimedia processing device, and wherein the method further comprises the step of translating the format of the multimedia content from the first format to a second format compatible with the host multimedia processing device.

18. The method as recited in claim 17, wherein the first format is compatible for use in a first time zone and the second format is compatible for use in a second time zone.

19. The method as recited in claim 10, further comprising the step of displaying multimedia content accessed by the host multimedia processing device on a display device coupled to the host multimedia processing device.

20. A computer readable medium storing instructions that, when executed on a programmed processor, carry out a method for accessing multimedia content associated with a home multimedia processing device using a host multimedia processing device, comprising:
instructions for receiving, in response to authentication of an end user of the home multimedia processing device, at least one of end user profile information and electronic program guide (EPG) information by the host multimedia processing device that has been provided for use by the multimedia processing device, wherein the end user profile information is associated with the end user of the home multimedia processing device and wherein the EPG information is associated with the home multimedia processing device;
instructions for accessing by the host multimedia processing device multimedia content associated with the end user and the home multimedia processing device, based on the received end user profile information and EPG information; and
instructions for controlling the access of the multimedia content received by the host multimedia processing device based on the received end user profile information and EPG information.
